(19) United States
(12) Patent Application Publication
(10) Pub. No.: US 2017/0032302 A1
(43) Pub. Date: Feb. 2, 2017

(54) SMART CONSTRUCTION OR OPERATIONS SITE METHOD AND APPARATUS

(71) Applicant: Lennar Pacific Properties Management, Inc., Miami, FL (US)

(72) Inventors: Laura Lete, St. Augustine, FL (US); Stephen Smith, Miami, FL (US); Christopher Oakes, Miami, FL (US)

(21) Appl. No.: 15/220,935

(22) Filed: Jul. 27, 2016

Related U.S. Application Data
(60) Provisional application No. 62/197,380, filed on Jul. 27, 2015.

(51) Int. Cl. G06Q 10/06; G06K 7/10; G06Q 50/08

(52) U.S. Cl. CPC G06Q 10/06313; G06Q 50/08; G06K 7/10297

(57) ABSTRACT

A system and method for managing and/or tracking of materials, equipment, or other components at an operations site, such as a construction site. The system may include tagging or marking of materials with one or more scannable or readable indicia (e.g., RFID tags) and associated scanners or readers configured to detect the materials via those indicia. The system may be configured to automatically or via user intervention, order materials, plan for material delivery, request employee or contractor work, or otherwise manage aspects of the a project being performed at the operations site in conjunction with the tracking of materials. The operations site may be networked (e.g., local Wi-Fi, connection with Internet, etc.) in order to allow on-site and off-site communication.

### CROSS REFERENCE TO RELATED APPLICATIONS

This application claims the benefit of U.S. Provisional Patent Application Ser. No. 62/197,380, filed on Jul. 27, 2015, entitled “SMART CONSTRUCTION OR OPERATIONS SITE METHOD AND APPARATUS,” which is hereby incorporated by reference in its entirety.

### BACKGROUND

1. Field of the Invention

The present invention relates to a method and apparatus for allowing improved tracking for an operations site. More particularly, the present invention relates to a tracking and/or logging and/or management system for an operations or construction site based upon tagging of materials and/or products to be received therein.

2. Description of the Related Art

The home or residence construction market requires a substantial amount of resource management in order to efficiently build and/or repair residential, commercial, and/or other properties. Buildings and other property elements require a large variety of materials for their construction, those materials requiring ordering and/or shipment to the build site for their eventual use. Unfortunately, a number of problems exist in the current construction process that hinders the efficient ordering and/or use of these various materials.

First, theft has become an increasingly common issue, particularly for high-value materials like copper piping. Due to the nature of the construction process, materials and other equipment needed for a build oftentimes must be deposited at or near a worksite prior to its immediate use. As such, after the construction crew has left for the day, it is common for various materials to still be sitting at the site, but not yet installed, lending to their more convenient theft, either for resale or for use on other construction projects.

Second, project planning for a construction, particularly a large scale job, can result in a number of inefficiencies due to unplanned delays (or faster-than-expected) completion times for various job tasks. When either occurs, subsequent work schedule may be impacted, either due to resources being unavailable, and/or resources being available but inefficiently having to wait for prior work to be completed first before they can begin. Third, as construction or other operations sites are oftentimes located on borders or outskirts of established cities or towns (e.g., as the city expends), it is not uncommon for cell service or other communications coverage to be lacking. As such, employees working at the site often have minimal means to communicate either with other workers at the site and/or with the company remotely.

Any of the above problems, among others, increase the cost, reduce efficiency, and add difficulties to operations management, particularly the larger the operation (e.g., large-scale construction of an apartment complex or neighborhood development). Ideally, an operations or construction site would have communication abilities to allow for efficient reporting and/or requesting of work or other necessary communications. In addition, an ideal system would allow for dynamic allocation of resources based upon immediate needs as the project progresses and/or for the elimination of theft or other problems, as discussed above. Thus, there is a need for an improved system or method of operations or worksite management and/or tracking to address or solve one or more of the above mentioned difficulties inherent in conventional operations.

### SUMMARY

The present invention is related to a method and/or system and/or apparatus for improved management and/or tracking of materials or product at an operations or construction site. In one embodiment, a method of managing an operations site may include providing a processor, providing a memory in communication with the processor, providing a component that is tagged with a unique identifier, providing a detecting element at the operations site, the detecting element configured to detect a presence of the component via the unique identifier, detecting when the component is within a predetermined proximity of the detecting element, storing data associated with the component, in the memory, when the component is detected, determining, using the processor, if the component was approved to be detected within the predetermined proximity of the detecting element, and determining, using the processor, a response based upon the determining if the component was approved to be detected within the predetermined proximity of the detecting element.

In another embodiment, a system for managing an operations site may include a component that is tagged with a unique identifier, a detecting element at the operations site, the detecting element configured to detect a presence of the component via the unique identifier, the detecting element configured to transmit information associated with the component when the component is detected by the detecting element, and a processor configured to receive the information associated with the component from the detecting element. The processor may be further programmed to generate a response based upon the information associated with the component and determine if the component was approved to be detected by the detecting element.

### BRIEF DESCRIPTION OF THE DRAWINGS

The features, objects, and advantages of the present invention will become more apparent from the detailed description set forth below when taken in conjunction with the drawings, wherein:

FIG. 1 shows a block diagram of a system implementing operations site management and/or tracking according to one embodiment of the present invention;

FIG. 2 shows a block diagram of an operations site implementing a system having management and/or tracking capabilities according to one embodiment of the present invention;

FIG. 3 shows a block diagram of a system implementing operations site management and/or tracking according to one embodiment of the present invention;

FIG. 4 shows a flow diagram describing a method of implementing operations site management and/or tracking according to one embodiment of the present invention; and

FIG. 5 shows a flow diagram describing a method of implementing operations site management and/or tracking according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

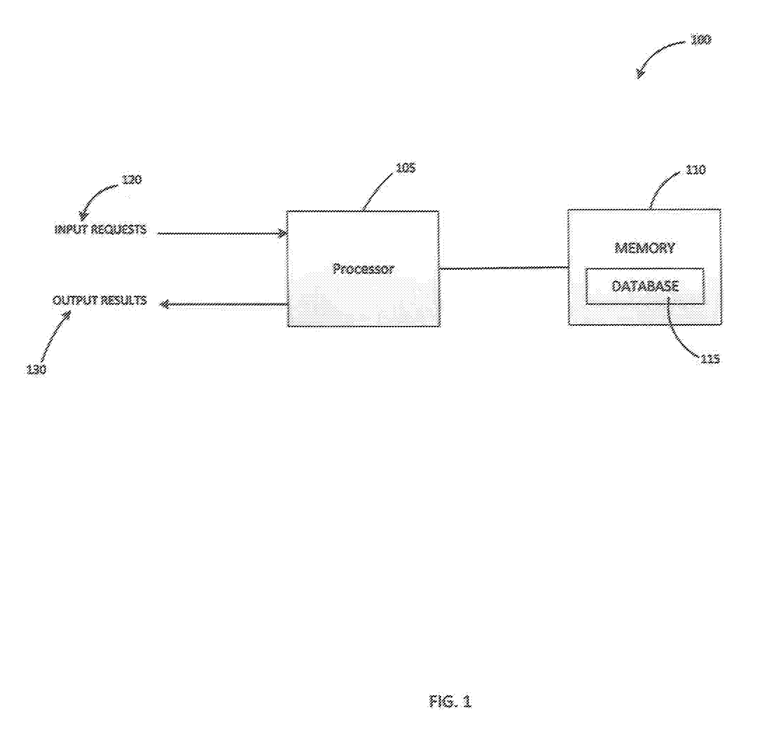

Turning first to FIG. 1, a block diagram of a system 100 is shown that may implement a management and/or tracking system, for example, via executing or running a software application thereon. For example, the software application may include features that are the same as or similar to those discussed herein. The system 100 includes a processor 105 connected with a memory 110, the memory 110 configured to store data. The processor is configured to interface or otherwise communicate with the memory, for example, via electrical signals propagated along a conductive trace or wire. In an alternative embodiment, the processor 105 may interface with the memory 110 via a wireless connection. In one embodiment, the memory 110 may include a database 115, a plurality of data or entries capable of being stored in the database 115 of the memory 110. For example, as discussed in greater detail herein, the memory 110 and/or the database 115 may store information about build materials, scheduling information, shipping information, necessary materials for construction of a home, building, or other property site, etc. Various of this information may be utilized for tracking, logging, and/or determining of information related to an operations and/or construction site, for example, as discussed in greater detail herein in various of the disclosed embodiments.

As discussed in greater detail below, the processor 105 may be tasked with executing software or other logical instructions in order for the management and/or tracking features to function as desired. Input 120 may be received by the processor 105 (e.g., via signals transmitted from a remote system or device (e.g., user-based or not), such as a RFID reader or other sensing device that is capable of communicating with a processor, to the processor 105 via a network or Internet connection). In an alternative embodiment, the input 120 may be received by the processor via a device that is not at a geographically remote location (e.g., via a connected mobile device, such as a handheld scanner that may plug in via USB or other hardwired connection) into the system 100 to provide the input 120. After performing tasks or instructions based upon the input 120, for example, looking up information or data stored in the memory 110, the processor 105 may provide output 130 to a remote system or computer based upon the input 120. In an alternative embodiment, any of a variety of systems capable of receiving input data, accessing stored data, processing software instructions, and/or transmitting output data may be utilized.

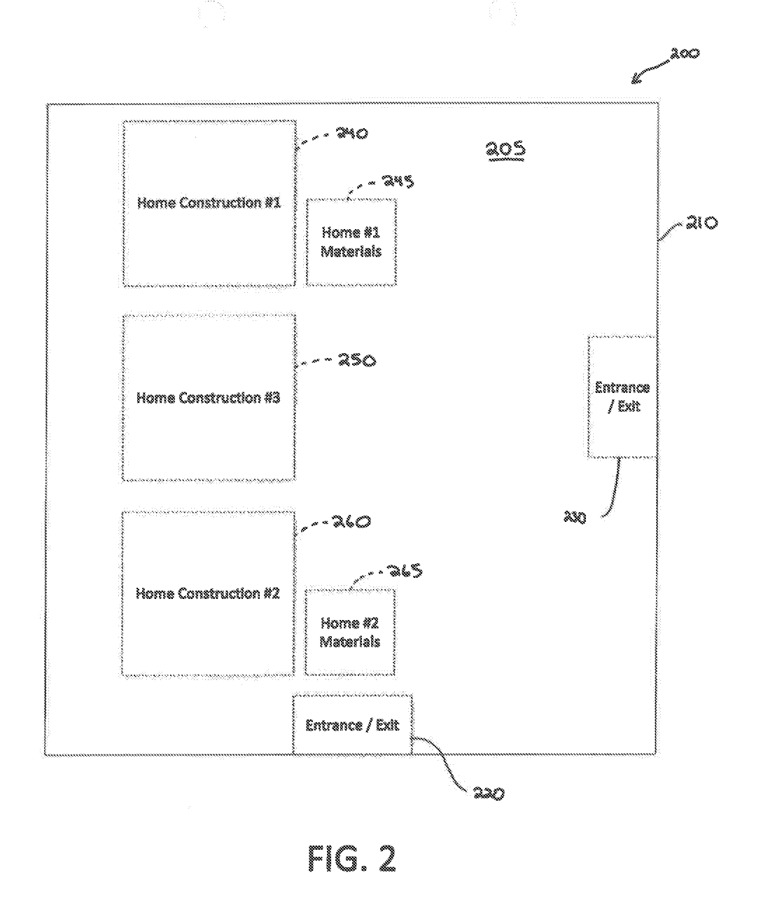

Turning next to FIG. 2, a block diagram of an operations site 200 (e.g., a home or real property construction site) is shown that implements a system having management and/or tracking capabilities. For example, the operations site 200 may include a first area 240 (e.g., a geographical boundary) for the construction of a first home, building, and/or property. The first area 240 may be defined by property boundary lines, size of the construction of the home, and/or any of a variety of other definitions. A first materials area 245 may also be disposed within the operations site 200 (e.g., adjacent and/or nearby to the first area 240). Thus, for example, materials such as lumber, steel, piping, appliances, glass, or a variety of other materials or components may be staged or stored near the first area 240 such that they may be used in the construction and/or furnishing of a home or building that is being manufactured in the first area 240.

Likewise, as illustrated, the operations site 200 may include a second area 260 (e.g., a geographical boundary) for the construction of a second home, building, and/or property. Similar to the description above, the second area 260 may be defined by property boundary lines, size of the construction of the home, and/or any of a variety of other definitions. A second materials area 265 may also be disposed within the operations site 200 (e.g., adjacent and/or nearby to the second area 260). Thus, for example, materials such as lumber, steel, piping, appliances, glass, or a variety of other materials or components may be staged or stored near the second area 260 such that they may be used in the construction and/or furnishing of a home or building that is being manufactured in the second area 260. In an alternative embodiment, the materials areas (245, 265) may be disposed at any of a variety of locations (and/or combined into one location) within the operations site 200.

In one example, one company, group, or other entity may own and/or be responsible for the construction of the homes, buildings, and/or properties represented by the first and second areas (240, 260, respectively). A second company, group, or other entity (e.g., diff from the first company, group, or other entity) may own and/or be responsible for the construction of a third home, building, and/or property at third area 250. This may occur, for example, in a neighborhood of homes where different builders or manufacturers are responsible for differing properties in such neighborhood. In other examples, one company, group, or other entity may own and/or be responsible for all properties that fall within a given operations site 200.

Continuing with the example of multiple, different manufacturers and/or builders within an operations site 200, the present invention's capabilities of managing and/or tracking of materials may provide a company with better information about how their materials are being used. For example, as previously mentioned, one problem with traditional worksites is the loss of materials due to theft, misplacement, etc. Not only can such theft occur from outside parties that sneak onto the worksite to remove materials (e.g., lumbar, copper, etc.) from the site completely, but may also occur when manufacturers or builders from their build areas (e.g., third area 250) utilize equipment and/or materials from other build areas (e.g., first area 245 and/or second area 265). As discussed in greater detail below, materials may be tracked within the operations site 200 in order to prevent and/or determine where materials are used.

The operations site 200 may be configured to contain equipment capable of detecting and/or communicating position of materials to a system (e.g., a remote, centralized system, such as one containing features described for FIG. 1). In one embodiment, materials, equipment, and/or other components that are to be transported and/or used within the operations site 200 may be tagged (e.g., with one or more radio frequency identification (“RFID”) tags). One or more equipment (e.g., RFID scanners) may then be disposed at and/or in the operations site 200 in order to detect the presence of these RFID tags. Although RFID tagging/sensing is described for the embodiment illustrated herein, in alternative embodiments, any of a variety of tagging, marking, or otherwise identifying indicia (e.g., barcodes, QR codes, etc.) may be provided for such materials and sensed or detected.

In one embodiment, video analytics may be utilized for tracking and/or management of an operations site. For example, a video camera with analytics capabilities or connected software may be capable of providing alerts (e.g., job site events, environmental changes, etc.). In one example, a camera with such analytics may be configured to keep track (e.g., count) the number of individuals entering or leaving an area. In another example, a camera with analytics may be configured to provide notifications when rain has started at an operations site. In still another example, a camera with analytics may be provided to provide data regarding progress of a job site (e.g., may detect and/or transmit information regarding how many homes are being built in a community, the stage each home build is in, such as foundation, in framing, in final stage of construction, etc.). Video camera analytics may be performed as an alternative to the tagging/detecting system previously described and/or may be performed in addition to such tagging/detecting for an operations site. In certain embodiments, the establishment of a network, such as a Wi-Fi network, for an operations site may establish the networking and/or connectivity that is used by such a camera, or other detecting equipment, to communicate information with outside systems (e.g., via the Internet).

In certain embodiments, software embedded within operations site equipment may be able to report productivity and/or maintenance information to other systems (e.g., system located remotely from the operations site). Additionally, in certain embodiments, an area or trailer located locally at an operations site may allow employees to interact with a remote system (e.g., using a network, such as a Wi-Fi network discussed herein) to access and/or manipulate documents, software (e.g., design models, such as 3 dimensional designs, communications like video conferencing, etc.). Further, in certain embodiments, vehicles or other mobile or rolling equipment may be able to report (e.g., in real time) productivity, environment, and/or other diagnostics data to a system while the vehicle uses data (e.g., data received from the system) to guide its autonomous or semi-autonomous operation.

For example, although materials have been primarily discussed as being tracked at the operations site, in certain embodiments, other elements may be tracked and/or managed using concepts of the present invention. For example, wearable elements (e.g., portable badges, tags, sensors, etc.) may be carried or worn by one or more employees of an operations site. In one embodiment, the detection and/or tracking of such wearable elements may be used to authorize and/or restrict access of individuals to certain areas of the operations site. In certain embodiments, portable elements that are capable of being tracked may also transmit or provide additional data for analysis by the system, for example environmental conditions and/or biometrics (e.g., to monitor employee safety).

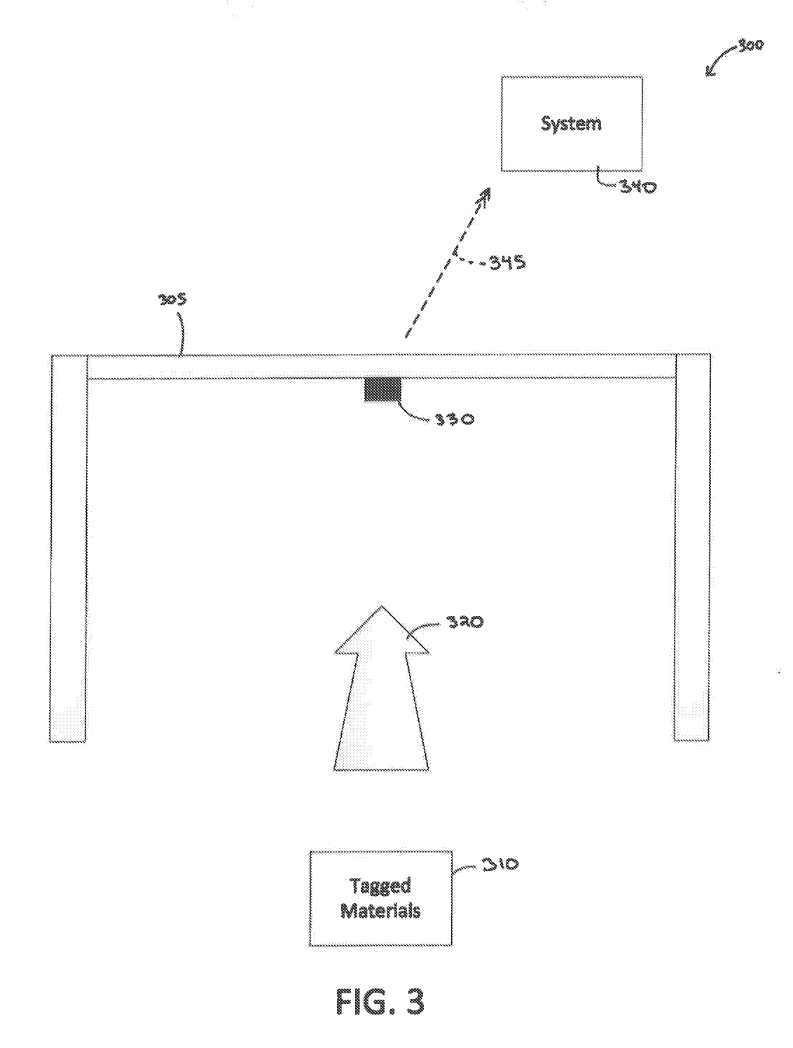

As illustrated, the operations site 200 may include one or more entrance/exit areas (220, 230) that facilitate the movement of materials, equipment, or other elements into and/or out of the operations site 200. As discussed in greater detail herein (e.g., see FIG. 3), tracking and/or other sensing equipment located at or near the entrance/exit areas (220, 230) may be used to determine if or when such materials are entering or leaving the operations site 200. Further, in certain embodiments, additional and/or alternative tracking and/or sensing equipment may be located at or near other locations at the operations site 200 (e.g., along roadways, near the first, second, and/or third areas (240, 260, 250), near the first and/or second material areas (245, 265), etc.) Indeed, any of a variety of locations may include such tracking and/or sensing equipment as desired for determining where, when, and/or what materials are present and/or moving around the operations site 200. This may help determine if and/or when a given material has arrived on site, has been delivered to a given materials area, has been used in a construction area, and/or has been removed from the site. Not only can such information help reduce and/or determine when and/or how a theft has occurred, but can also help (e.g., automate) management of the operations site 200, as discussed in greater detail herein.

In still other embodiments, as illustrated, a boundary 210 for the operations site 200 may be established and a network 205 (e.g., a Wi-Fi network) may be established within the boundary 210. As previously noted, one problem with conventional construction sites, particularly in those sites involving new developments on a border or outskirts of an established town or city, is the lack of adequate network connections. For example, if a new housing development is being built in an area that has limited or no cell tower coverage (e.g., due to the area being previously undeveloped), it can be difficult for workers or employees within the development to communicate with each other and/or others at their company. For example, this lack of efficient communication can be problematic when supplies need to be ordered and/or delivered to the operations site 200. The establishment of the network 205 for the operations site 200 can allow those employees to easily connect a variety of electronic devices (e.g., smart phones, tablets, etc.) and use the network for in-network communication with others at the operations site 200 and/or remotely (e.g., if the network 205 can connect with outside networks, for example, via the Internet). In certain embodiments, the network 205 communication with outside networks or systems may allow for the sending of information regarding scanned and/or tracked materials and/or other objects, the same as or similar to the previous discussion and/or other embodiments discussed herein.

Any of a variety of industries may see benefit from a Wi-Fi or other network-enabled operations site. For example, in one embodiment, a Wi-Fi enabled site may be utilized in a coal-mining context wherein vehicles and/or machinery are tracked (e.g., via RFID technology). In another example, in one embodiment, a Wi-Fi enabled site may be utilized in a sea-port or shipping context wherein ports and/or streets allow for shipping containers to be tracked and/or delivered via optimal routes that are determined by the system based upon such tracking and/or relay of such tracking via the Wi-Fi network. In yet another example, in one embodiment, a Wi-Fi enabled site may be utilized in a manufacturing context wherein a manufacturing floor allows for tracking of assembly and/or materials, the tracking data allowing for optimization of waste and/or other manufacturing processes while reducing theft.

FIG. 3 shows a block diagram of a system 300 implementing operations site management and/or tracking. The database system 300 and/or other aspects may include features that are the same as or similar to those previously discussed. As discussed herein, the system 300 may allow for more efficient tracking and/or management of materials, equipment, and/or other components for use in or at an operations site. FIG. 3 illustrates one or more tagged materials 310 (e.g., each material having its own unique tag and/or a set of materials being tagged with one unique tag) that is desired for entry and/or exit to an operations site. In one example, if multiple discrete materials (e.g., screws, nails, lumber, etc.) are grouped together and tagged with one tag (e.g., a box of screws tagged with a single tag, rather than each individual screw having its own tag) any of a variety of additional manners may be used for determining usage in order to more effectively track usage. For example, standard usage rates may be used for determining usage upon scanning of a grouped item (e.g., if an operations site will typically go through X number of screws in a given day, upon scanning a box of screws, the system will estimate that such X number will be used each day and may reorder or reallocate more screws based upon such estimate). In another example, additional systems may be utilized (e.g., a box of screws may be placed onto a platform capable of determining its weight and the system may know the weight of an individual screw such that when below a predetermined threshold, the system reorders or reallocates more screws based upon such weight). In still another example, a video camera with analytic capabilities may be able to determine when items are used (e.g., if a group of lumber is tagged with one tag, a video camera may be able to automatically determine when individual boards of such lumber are removed and/or used for a build).

As shown, a structure 305 may be disposed at or within the operations site and coupled with a scanner 330 or other detector of the one or more tags associated with the tagged materials 310. When the tagged materials travel 320 within a proximity of the scanner 330 (e.g., by traveling through or nearby the structure 305, the scanner 330 detects the presence of the one or more tags associated with the tagged materials 310. Information associated with these one or more detected tags is then communicated 345 to a system 340 (e.g., a remote system) for additional data analysis, storage, and/or management.

In one example, as previously discussed, the sending of data regarding the entrance/exit of uniquely identified tagged materials within an operations site (or some subset of an operations site) may help deter or identify theft and/or misplaced items. For example, the data communicated 345 to the system 340 may specifically identify a particular tagged material 310, its location when detected within or at the operations site, a time of its detected location within or at the operations site, among other possible data. As this tagged material 310 moves around the operations site, the same scanner 330 and/or other scans may re-detect the tagged material 310 and similarly communicate 345 with the system 340 such that its position in time is known.

In another example, the sending of data regarding the entrance/exit of uniquely identified tagged materials within an operations site (or some subset of an operations site) may allow for more efficient (e.g., automated) ordering, shipment, and/or movement of materials, equipment, or other components. In one embodiment, as a home, building, or other property is being constructed and/or worked on, differing materials and/or equipment may be needed at different times in the process. Managing this schedule is conventionally handled at the start of a project, but can be inefficient as construction developments either slow down or speed up the need for one or more of these materials or equipment in a manner that differs from the originally scheduled plan. The present invention may allow for automation of material or equipment scheduling that can result in less expensive and/or more efficient construction efforts.

For example, the system 300 may detect via scanner 330 that a particular tagged material 310 (e.g., wood used for framing a home) has been transferred from a material storage zone of a worksite to the particular geographic site where the home is being built, indicating that the framing of the house has been started or will soon be started. This information is communicated 345 to the system 340. If this tagged material 310 is detected at an earlier time than was previously planned for (or if no original plan was proceeded), the system 340 would regardless be able or configured to know which process, step, and/or materials or equipment would likely be needed next (e.g., upon framing being completed, windows should be installed).

Upon such determination, the system 340 may be able or configured to see if any such next-needed materials or equipment or personnel are available, schedule for order or transport/delivery of such materials, update employee schedules or request a work order for such next-needed work (e.g., an employee skilled with installation of windows/doors), or any of a variety of other associated tasks or needs. The process may then subsequently continue in a similar manner to that described above using the scanner 330 and the next-needed tagged materials 310 until project completion. In this fashion, a construction project may be dynamically planned, with materials being ordered, delivered, shipped, used, etc. by employees that are requested and/or dispatched as needed while the project progresses, via the management and tracking of tagged materials 310 (and/or other tagged objects or people, such as employees). Any of a variety of objects may be tagged and any of a variety and/or number of scanners or other readers may be disposed at a variety of worksite locations (or off-site locations) in order to effectuate the tracking and/or management features, the same as or similar to discussed above.

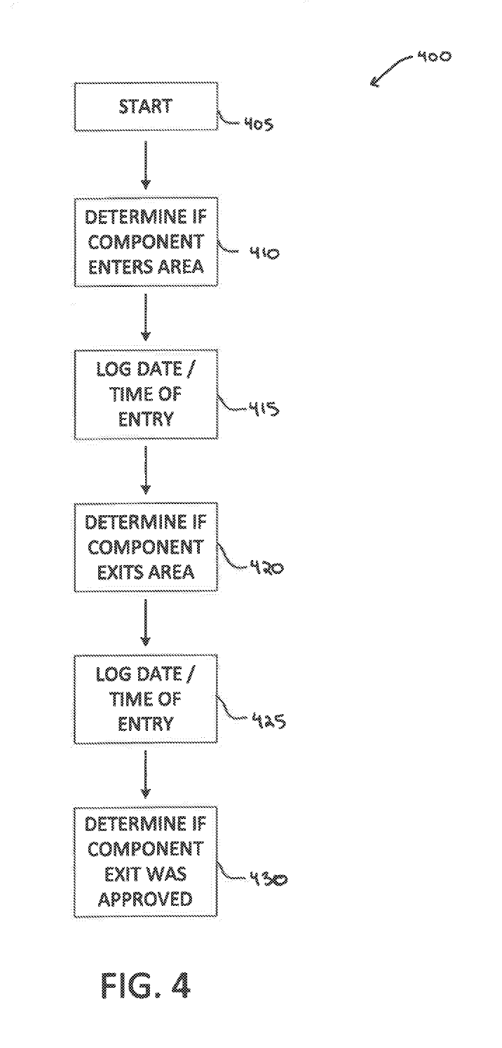

FIG. 4 shows a flow diagram 400 describing a method of implementing operations site management and/or tracking. The method may include features and/or operation that are the same as or similar to those previously discussed. As illustrated, the flow diagram 400 (e.g., implemented by various equipment associated with an operations site, such as scanners, tagged materials and/or components, remote or local systems in communication with the scanners, etc.) starts at step 405, such as when an operations or construction site is initially established (e.g., includes scanning/detecting equipment installed and/or with network operation to allow communication from such scanning/detecting equipment) and when materials, components, and/or equipment that is to be received at or moved within the operations or construction site is appropriately tagged or marked with scannable elements.

At step 410, it is determined whether the material, component, and/or equipment has entered a particular area or crossed by a predefined boundary (e.g., via scanning equipment scanning the one or more tags associated with the material, component, and/or equipment), the same as or similar to previous discussions. At step 415, this detection and/or information associated with the detection and/or tag may be sent to a system (e.g., either a remote and/or a local system) and a log created of the date and/or time of such detection. For example, this log may be stored in a memory and/or database, the same as or similar to discussed above for FIG. 1.

At step 420, the same as or similar to step 410, it is determined whether the material, component, and/or equipment has entered a particular area or crossed by a predefined boundary (e.g., via scanning equipment scanning the one or more tags associated with the material, component, and/or equipment), the same as or similar to previous discussions. Moreover, similar to step 415, at step 425 this detection and/or information associated with the detection and/or tag may be sent to a system (e.g., either a remote and/or a local system) and a log created of the date and/or time of such detection. In this fashion, as various materials move throughout an operations site or a worksite, entering and/or exiting different defined areas and/or passing by particular locations of interest, the movement of such items may be ascertained. At step 430, such movement and/or exiting of a particular material, equipment, and/or component can be analyzed to determine whether such movement was approved and/or expected.

For example, if a particular item was intended to be moved into a worksite and delivered to a staging or storage area for subsequent use during the build of a home, if such material is subsequently determined to move from such location (either to another known location or to an unknown location), the system may be configured to flag, send an alert, or transmit another such notification, such movement as a potential problem. Such flagging and/or notifying may result in individuals being dispatched to the worksite and/or location to determine where or why a particular material moved, automatically order new materials and/or schedule for their delivery to replace the missing material, etc. Any of a variety of remedial or further actions may be taken at or after step 430 based upon the system's programming and/or analysis of the particular material that moved.

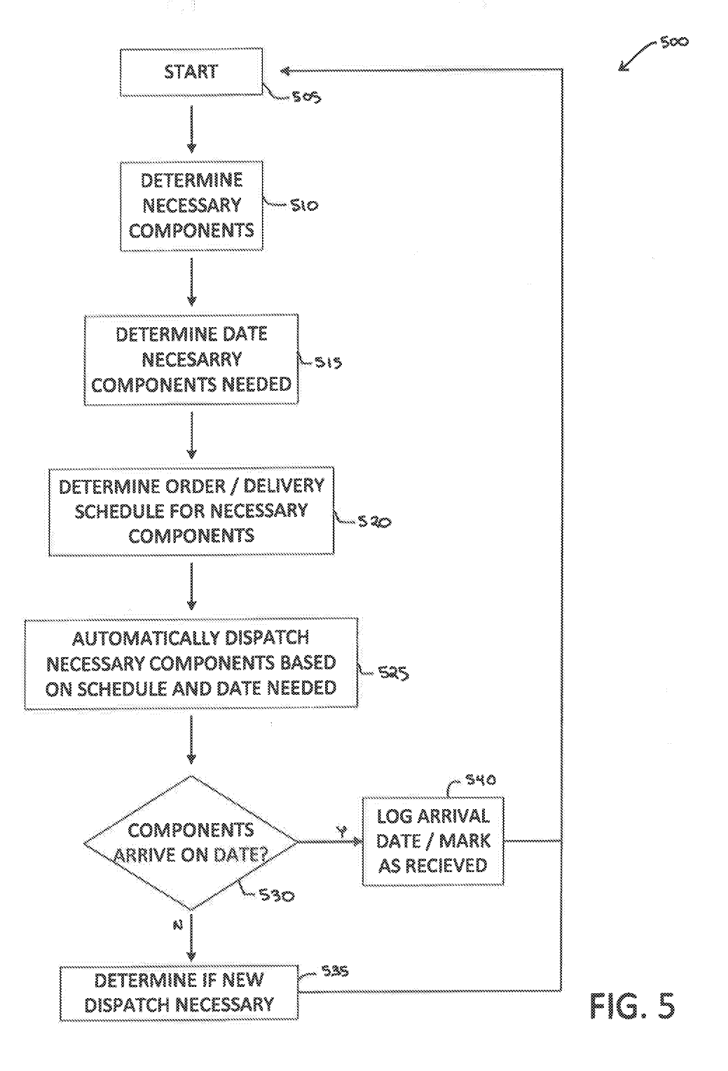

Turning lastly to FIG. 5, a flow diagram 500 is shown describing a method of implementing operations site management. The method may include features and/or operation that are the same as or similar to those previously discussed. As illustrated, the flow diagram 500 (e.g., implemented by various equipment associated with an operations site, such as scanners, tagged materials and/or components, remote or local systems in communication with the scanners, etc.) starts at step 505, such as when a project (e.g., a home build) is established with a bill of materials and/or equipment to be installed and/or used for manufacture and/or construction of a property. As previously discussed for various embodiments, an operations or construction site may be established (e.g., includes scanning/detecting equipment installed and/or with network operation to allow communication from such scanning/detecting equipment) and materials, components, and/or equipment that is to be received at or moved within the operations or construction site may be appropriately tagged or marked with scannable elements.

At step 510, the components necessary for a particular project or build may be determined. For example, a system may have compiled a list of materials and/or equipment for a particular building or property (e.g., the materials being manually entered to the system and/or automatically generated, such as via a starting template that may be modifiable, which identifies all or some of the materials and/or equipment necessary for effectuating the project. Similarly, at step 515, a date and/or time and/or other schedule for when one or more of the components of step 510 are needed for a given build (e.g., if concrete for a foundation is needed at time 1, lumber needed for framing may be needed at time 1+duration 1 and/or at time 2).

At step 520, an order or delivery schedule for the necessary components of step 510 (e.g., at times determined at step 515) is determined. For example, if a project is scheduled or desired to start at date 1 and concrete is desirably needed on that same date, but it takes 2 weeks to order, ship, request employees to pour, etc., an order or delivery schedule for the concrete may establish that ordering of the material needs to occur at least upon date 1 minus 2 weeks. Performing this step for some or all of the components of step 510 due to their respective needed times determined at step 515, the system may be configured to manage all or some of the schedule for a given project. Using this information, and based upon delivery receipt and/or movement of materials within an operations site (e.g., as previously discussed), the system may automatically dispatch orders, shipments, employees, etc. at step 525. In an alternative embodiment, dispatch and/or other activities based upon the schedule and date needed of particular components may not be fully automatic, or may be manual based (e.g., the system may alert as to a need for additional material ordering, shipment, employee work requests, etc., but require manual input to effectuate such a response to the notification).

At step 530, it is determined whether particular components (e.g., some or all of the components determined to be necessary at step 510 and/or dispatched at step 525 have arrived at the desired and/or ordered location. For example, this may be accomplished using scanners or other detecting elements in conjunction with tagging and/or other detectible elements that are associated (e.g., stamped, coupled, or otherwise corresponding) to the particular materials, the same as or similar to previous discussions.

If the components did arrive on time (e.g., determined via the system from received information from scanners at the operations site in comparison to a stored schedule of the system), such arrival date, location, and/or other information is stored in the system at step 540. Operation may then continue back to step 505 where the process begins anew, for example, for a new project. However, if the components did not arrive on time (e.g., similarly determined via the system from received information from scanners at the operations site in comparison to a stored schedule of the system), the system determines whether additional dispatch and/or other response is necessary at step 535. For example, the system may determine that the desired component did not arrive, but may be replaced while it is further determined why arrival did not occur via dispatching of a same or similar material from another location (e.g., from elsewhere within the operations site, from a different worksite, and/or by re-ordering or requesting the component again from a third party or from company storage). In another example, the system may determine that the desired component arrived, but was delivered to an incorrect location so should simple be transferred to the desired location. Indeed, any of a variety of responses may be taken by the system, either automatically or via manual intervention by a user (e.g., based upon a system notification).

The previously discussed operations site functionality, systems, equipment, and/or methods may include features and/or operation different from those stated in the exemplary embodiments detailed above. Features and/or operation in one embodiment may also or additionally be included with features and/or operation of a separately discussed embodiment. Moreover, features may be added, removed, or executed with different operative flow from the exemplary embodiments detailed above. For example, in one embodiment, an operations site or associated system and/or software may be configured to support tracking and/or management of components across different operations sites (e.g., company-wide tracking).

The previous description of the disclosed examples is provided to enable any person of ordinary skill in the art to make or use the disclosed methods, system, and/or apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. A method of managing an operations site, the method comprising the steps of:
providing a processor;
providing a memory in communication with the processor;
providing a component that is tagged with a unique identifier;
providing a detecting element at the operations site, the detecting element configured to detect a presence of the component via the unique identifier;
detecting when the component is within a predetermined proximity of the detecting element;
storing data associated with the component, in the memory, when the component is detected;
determining, using the processor, if the component was approved to be detected within the predetermined proximity of the detecting element; and
determining, using the processor, a response based upon the determining if the component was approved to be detected within the predetermined proximity of the detecting element.

2. The method of claim 1 wherein the response is a notification to be displayed to a user;

3. The method of claim 1 wherein the response is an order for a second component.

4. The method of claim 1 wherein the unique identifier is an RFID tag.

5. The method of claim 1 wherein the data associated with the component includes a date or time when the component was detected.

6. The method of claim 5 wherein the data associated with the component includes identification of the detecting element that detected the component.

7. The method of claim 5 wherein the data associated with the component includes a location of the component when the component was detected.

8. A system for managing an operations site comprising:
a component that is tagged with a unique identifier;
a detecting element at the operations site, the detecting element configured to detect a presence of the component via the unique identifier, the detecting element configured to transmit information associated with the component when the component is detected by the detecting element; and
a processor configured to receive the information associated with the component from the detecting element, the processor programmed to:
generate a response based upon the information associated with the component, and
determine if the component was approved to be detected by the detecting element.

9. The system of claim 8 wherein the detecting element is configured to transmit the information associated with the component via the Internet.
